(19) United States
(12) Patent Application Publication
(10) Pub. No.: US 2024/0170724 A1
(43) Pub. Date: May 23, 2024

(54) ELECTROLYTE SOLUTION FOR LITHIUM SECONDARY BATTERY AND LITHIUM SECONDARY BATTERY COMPRISING THE SAME

(71) Applicants: Hyundai Motor Company, Seoul (KR); Kia Corporation, Seoul (KR); Korea Advanced Institute of Science and Technology, Daejeon (KR)

(72) Inventors: Ko Eun Kim, Cheongju-si (KR); Sung Ho Ban, Hwaseong-si (KR); Yoon Sung Lee, Suwon-si (KR); Jun Ki Rhee, Suwon-si (KR); Hui Beom Nam, Hwaseong-si (KR); Hyeon Gyu Moon, Daejeon (KR); Nam-Soon Choi, Daejeon (KR); Jeong Woo Lee, Ulsan (KR); Sung You Hong, Ulsan (KR)

(21) Appl. No.: 18/504,412

(22) Filed: Nov. 8, 2023

(30) Foreign Application Priority Data
Nov. 16, 2022 (KR) 10-2022-0153803

(51) Int. Cl. H01M 10/0567; H01M 4/38; H01M 4/583; H01M 10/052; H01M 10/0568; H01M 10/0569; H01M 50/46; H01M 4/02

(52) U.S. Cl. CPC H01M 10/0567; H01M 4/386; H01M 4/583; H01M 10/052; H01M 10/0568; H01M 10/0569; H01M 50/46; H01M 2004/027; H01M 2004/028; H01M 2300/0028

(57) ABSTRACT

An embodiment electrolyte solution includes a lithium salt, a solvent, and a functional additive, wherein the functional additive includes an electrode film additive of 2-(dodec-1-en-2-yl)-4,4,5,5-tetramethyl-1,3,2-dioxaborolane represented by

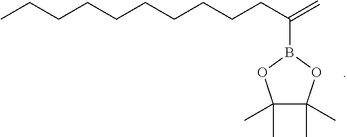 [SMILES: C=C(CCCCCCCCCC)B1OC(C)(C)C(C)(C)O1]

An embodiment lithium secondary battery includes this electrolyte solution, a positive electrode including a positive-electrode active material including Ni, Co, and Mn, a negative electrode including a negative-electrode active material including a carbon (C)-based material or a silicon (Si)-based material, and a separator interposed between the positive electrode and the negative electrode.

### CROSS-REFERENCE TO RELATED APPLICATIONS

This application claims the benefit of Korean Patent Application No. 10-2022-0153803, filed on Nov. 16, 2022, which application is hereby incorporated herein by reference.

### TECHNICAL FIELD

The present disclosure relates to an electrolyte solution for a lithium secondary battery and a lithium secondary battery including the same.

### BACKGROUND

A lithium secondary battery is an energy storage system including a positive electrode providing lithium and a negative electrode receiving the lithium during charging, an electrolyte serving as a lithium ion transfer medium, and a separator separating the positive electrode and the negative electrode from each other. The lithium secondary battery generates and stores an electric energy through a change of chemical potentials when intercalation/deintercalation of lithium ions is performed at the negative and positive electrodes.

The lithium secondary battery has mainly been used in a portable electronic device, but recently, with the commercialization of an electric vehicle (EV) and a hybrid electric vehicle (HEV), the lithium secondary battery has also been used as an energy storage means of the electric vehicle and the hybrid electric vehicle.

Meanwhile, the performance of the lithium secondary battery is determined by the characteristics of a positive electrode, a negative electrode, a separator, and an electrolyte, which are four core materials.

In particular, the commercialization of electric vehicles, which are eco-friendly vehicles, can be accelerated by improving energy density in unit cells to improve mileage. In addition, to this end, low-cost, rapid charge and discharge technologies, and high safety technologies are also essential.

In addition, the importance of low-viscosity solvents and additives included in the electrolyte of the lithium secondary battery is being emphasized to improve the battery performance and stability related to output.

Accordingly, recently, studies on increasing the energy density of the lithium secondary battery have been conducted in order to increase the mileage of an electric vehicle, and the increase in energy density of the lithium secondary battery is possible through higher capacities of the positive and negative electrodes.

In order to develop the lithium secondary battery having a high energy density, it is required to develop new materials that can overcome the performance limitations of existing materials for the lithium secondary battery such as a positive electrode, a negative electrode, a separator, and an electrolyte solution.

In particular, the energy density of a battery is highly dependent on the characteristics of positive and negative electrode materials, and an appropriate electrolyte solution must be developed in order for the positive and negative electrode materials to be developed to exhibit excellent electrochemical performance.

Even if the positive and negative electrode materials having high capacity are developed, if an appropriate electrolyte solution is not used, the residual components present on the surfaces of the positive and negative electrodes promote decomposition of the electrolyte solution, and the deterioration rate increases due to the increased interfacial reactivity with the electrolyte solution, resulting in rapid deterioration of charge and discharge performance.

Therefore, a technology for controlling an interface between the electrodes and the electrolyte solution is very important, and for this purpose, an additive technology capable of forming an electrochemically and chemically stable film is required.

The description given in the related art is only to understand the background of embodiments of the present disclosure, but should not be recognized as prior art already known to a person skilled in the art.

### SUMMARY

The present disclosure relates to an electrolyte solution for a lithium secondary battery and a lithium secondary battery including the same. Particular embodiments relate to an electrolyte solution for a lithium secondary battery capable of improving the lifespan and output characteristics of a lithium secondary battery of high capacity and a lithium secondary battery including the same.

Embodiments of the present disclosure provide an electrolyte solution for a lithium secondary battery capable of improving the lifespan and output characteristics of a lithium secondary battery and a lithium secondary battery including the same.

The technical objects that can be achieved through embodiments of the present disclosure are not limited to what has been particularly described hereinabove and other technical objects not described herein will be more clearly understood by persons skilled in the art from the following detailed description.

An electrolyte solution for a lithium secondary battery according to an embodiment of the present disclosure includes a lithium salt, a solvent, and a functional additive, wherein the functional additive includes an electrode film additive, which is 2-(dodec-1-en-2-yl)-4,4,5,5 -tetramethyl-1,3,2-dioxaborolane, represented by the following Formula 1.

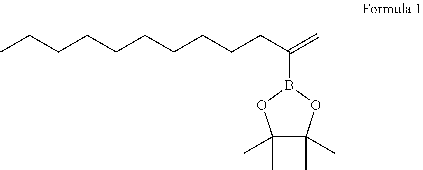 [SMILES: C=C(CCCCCCCCCC)B1OC(C)(C)C(C)(C)O1]

The electrode film additive is in an amount of 0.05 to 1.0% by weight based on a

weight of the electrolyte solution.

Preferably, the electrode film additive is in an amount of 0.05 to 0.1% by weight based on the weight of the electrolyte solution.

The functional additive further includes a negative-electrode film additive which is vinylene carbonate (VC).

Preferably, the vinylene carbonate (VC) is added in an amount of 0.5 to 3.0% by weight based on a weight of the electrolyte solution.

The lithium salt includes one or a mixture of two or more selected from the group consisting of LiPF₆, LiBF₄, LiClO₄, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, LiB(C₆H₅)₄, LiB(C₂O₄)₂, LiPO₂F₂, Li(SO₂F)₂N, LiFSI, and (CF₃SO₂)₂ NLi.

The solvent includes one or a mixture of two or more selected from the group consisting of a carbonate-based solvent, an ester-based solvent, an ether-based solvent, and a ketone-based solvent.

Meanwhile, a lithium secondary battery according to an embodiment of the present disclosure includes the above-described electrolyte solution. In addition, the lithium secondary battery further includes a positive electrode including a positive-electrode active material containing Ni, Co, and Mn, a negative electrode including a negative-electrode active material containing one or more selected from a carbon (C)-based material or a silicon (Si)-based material, and a separator interposed between the positive electrode and the negative electrode.

The positive electrode includes a Ni content of 60% by weight or more.

According to an embodiment of the present disclosure, it is possible to suppress deterioration of the cell by forming a protection layer of high ionic conductivity on the surfaces of the positive-electrode active material and negative-electrode active material by the electrolyte solution, so that the effect of increasing the lifespan of the lithium secondary battery and improving the battery output characteristics can be expected at the same time.

In addition, it is possible to improve the marketability of the battery by securing life stability at high temperature.

### BRIEF DESCRIPTION OF THE DRAWINGS

FIG. 1 is a view showing a working mechanism of an electrode film additive according to an embodiment of the disclosure.

FIG. 2 is a graph showing results of experiments for evaluating the lifespan capacity retention rate at high temperature for the type and amount change of a functional additive according to Examples and Comparative Examples.

FIG. 3 is a graph showing results of experiments for evaluating output performance at room temperature for the type and amount change of a functional additive according to Examples and Comparative Examples.

### DETAILED DESCRIPTION OF ILLUSTRATIVE EMBODIMENTS

Hereinafter, the embodiments disclosed in the present specification will be described in detail with reference to the accompanying drawings, and the same or similar elements are denoted by the same reference numerals even though they are depicted in different drawings and redundant descriptions thereof will be omitted.

In the following description of the embodiments disclosed in the present specification, a detailed description of known functions and configurations incorporated herein will be omitted when it may make the subject matter of the embodiments disclosed in the present specification rather unclear. In addition, the accompanying drawings are provided only for a better understanding of the embodiments disclosed in the present specification and are not intended to limit technical ideas disclosed in the present specification. Therefore, it should be understood that the accompanying drawings include all modifications, equivalents, and substitutions within the scope and spirit of the present disclosure.

It will be understood that although the terms first, second, etc., may be used herein to describe various components, these components should not be limited by these terms. These terms are only used to distinguish one component from another component.

The singular form is intended to include the plural forms as well, unless the context clearly indicates otherwise.

In the present application, it will be further understood that the terms “comprises,” “includes,” etc. specify the presence of stated features, integers, steps, operations, elements, components, or combinations thereof, but do not preclude the presence or addition of one or more other features, integers, steps, operations, elements, components, or combinations thereof.

The electrolyte solution for a lithium secondary battery according to an embodiment of the present disclosure is a material forming an electrolyte applicable to a lithium secondary battery and includes a lithium salt, a solvent, and a functional additive.

The lithium salt may be one or a mixture of two or more selected from the group consisting of LiPF₆, LiBF₄, LiClO₄, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, LiB(C₆H₅)₄, LiB(C₂O₄)₂, LiPO₂F₂, Li(SO₂F)₂N, LiFSI, and (CF₃SO₂)₂ NLi.

In this case, the lithium salt may be present at a concentration of 0.1 to 3.o moles, preferably 0.1 to 1.2 moles, in the electrolyte solution.

Also, the solvent may be one or a mixture of two or more selected from the group consisting of a carbonate-based solvent, an ester-based solvent, an ether-based solvent, and a ketone based solvent.

In this case, the carbonate-based solvent may be dimethyl carbonate (DMC), diethyl carbonate (DEC), dipropyl carbonate (DPC), methyl propyl carbonate (MPC), ethyl propyl carbonate (EPC), ethyl methyl carbonate (EMC), ethylene carbonate (EC), propylene carbonate (PC), butylene carbonate (BC), fluoroethylene carbonate (FEC), vinylene carbonate (VC), or the like. In addition, the ester-based solvent may be γ-butyrolactone (GBL), n-methyl acetate, n-ethyl acetate, n-propyl acetate, or the like. In addition, the ether-based solvent may be dibutyl ether, or the like, but is not limited thereto.

In addition, the solvent may further include an aromatic hydrocarbon-based organic solvent. Specific examples of the aromatic hydrocarbon-based organic solvent may include benzene, fluorobenzene, bromobenzene, chlorobenzene, cyclohexylbenzene, isopropylbenzene, n-butylbenzene, octylbenzene, toluene, xylene, mesitylene, and the like, and this solvent may be used alone or in combination.

Meanwhile, an electrode film additive, which is 2-(dodec-1-en-2-yl)-4,4,5,5 -tetramethyl-1,3,2-dioxaborolane (hereinafter referred to as “AAB-1”), represented by the following Formula 1, may be used as the functional additive added to an electrolyte solution according to an embodiment of the present disclosure.

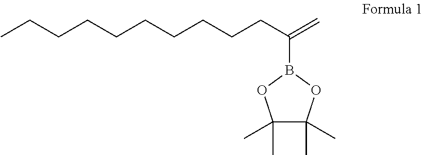 [SMILES: C=C(CCCCCCCCCC)B1OC(C)(C)C(C)(C)O1]

In this case, the electrode film additive, which is 2-(dodec-1-en-2-ye-4,4,5,5 -tetramethyl-1,3,2-dioxaborolane(AAB-1), forms a cathode-electrolyte interphase (CEI) and a solid electrolyte interphase (SEI), which are ion transport films with protective function, on the surfaces of the positive and negative electrodes.

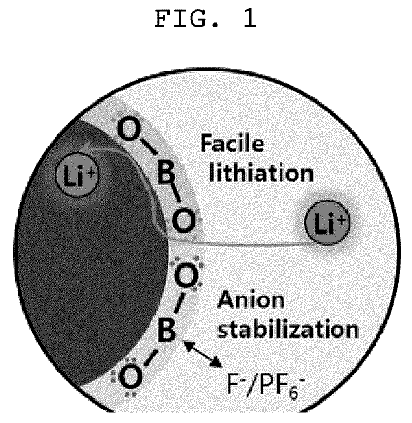

FIG. 1 is a view showing a working mechanism of an electrode film additive according to an embodiment of the present disclosure. By the electrode film additive, which is 2-(dodec-1-en-2-yl)-4,4,5,5-tetramethyl-1,3,2-dioxaborolane(AAB-1), added to the electrolyte solution, B—O-based CEI and SEI with ion transport and protective function are formed on the surfaces of the positive and negative electrodes. Accordingly, while suppressing the electrodeposition of lithium ions on the surfaces of the positive and negative electrodes, the insertion and deintercalation process of lithium ions on the positive and negative electrodes are facilitated.

In addition, the electrode film additive, which is 2-(dodec-1-en-2-34)-4,4,5,5 -tetramethyl-1,3,2-dioxaborolane(AAB-1), is preferably added in an amount of 0.05 to 1.0% by weight based on the weight of the electrolyte solution. Preferably, the electrode film additive is added in an amount of 0.05 to 0.5% by weight based on the weight of the electrolyte solution. More preferably, the electrode film additive is added in an amount of 0.05 to 0.1% by weight based on the weight of the electrolyte solution.

If the amount of the electrode film additive to be added is less than the above presented range, it is difficult to form a sufficient surface protective film on the surfaces of the positive and negative electrodes and thus a sufficient effect cannot be expected, and if the amount of the electrode film additive is more than the above presented range, the surface protective layer, CEI, and SEI, may be excessively formed and the cell resistance increases, and thus the lifespan of the cell may be deteriorated.

Meanwhile, as the functional additive, a negative-electrode film additive, serving to form a film on the negative electrode, may be further added together with the electrode film additive. For example, the negative-electrode film additive may be a vinylene carbonate (hereinafter referred to as “VC”).

In this case, the VC used as the negative-electrode film additive may be preferably added in an amount of 0.5 to 3.o % by weight based on the weight of the electrolyte solution. More preferably, the negative-electrode film additive may be added in an amount of 1.5 to 2.5% by weight.

If the amount of the negative-electrode film additive to be added is less than the above presented amount, there is a problem in that the long-term lifespan of the cell is deteriorated, and if the amount of the negative-electrode film additive is more than the above presented amount, there are problems in that the cell resistance may increase due to the excessive formation of the surface protective layer, resulting in reduced battery output.

Meanwhile, the lithium secondary battery according to an embodiment of the present disclosure includes a positive electrode, a negative electrode, and a separator, in addition to the above-described electrolyte solution.

The positive electrode includes an NCM-based positive-electrode active material containing Ni, Co, and Mn. In particular, the positive-electrode active material included in the positive electrode in this embodiment preferably contains only an NCM-based positive-electrode active material containing Ni in an amount of 60% by weight or more.

In addition, the negative electrode contains one or more selected from a carbon (C)-based negative-electrode active material and a silicon (Si)-based negative-electrode active material.

The carbon (C)-based negative-electrode active material may include at least one material selected from the group consisting of artificial graphite, natural graphite, graphitized carbon fiber, graphitized mesocarbon microbeads, fullerene, and amorphous carbon.

In addition, the silicon (Si)-based negative active material includes silicon oxide, silicon particles, and silicon alloy particles.

Meanwhile, the positive electrode and the negative electrode are produced by mixing each of the active materials with a conductive material, a binder, and a solvent to prepare an electrode slurry, and then directly coating a current collector with the electrode slurry, followed by drying. In this case, aluminum (Al) may be used as the current collector, but the present disclosure is not limited thereto. Since such an electrode production method is well known in the art, a detailed description thereof will be omitted.

The binder serves to promote adhesion between particles of each active material or adhesion thereof to the current collector. For example, the binder may be polyvinyl alcohol, carboxymethyl cellulose, hydroxypropyl cellulose, diacetyl cellulose, polyvinyl chloride, carboxylated polyvinylchloride, polyvinylfluoride, an ethylene-oxide-containing polymer, polyvinylpyrrolidone, polyurethane, polytetrafluoroethylene, polyvinylidene fluoride, polyethylene, polypropylene, styrene butadiene rubber, acrylated styrene butadiene rubber, an epoxy resin, nylon, or the like, but is not limited thereto.

In addition, the conductive material is used to impart conductivity to the electrode and any conductive material can be used as long as it is an electrically conductive material that does not cause a chemical change in the battery to be produced, and examples thereof include natural graphite, artificial graphite, carbon black, acetylene black, Ketjen black, carbon fibers, metal powders such as copper, nickel, aluminum and silver powders, metal fibers, and the like. In addition, a conductive material such as a polyphenylene derivative may be used alone or in combination.

The separator inhibits a short circuit between the positive electrode and the negative electrode and provides a passage for lithium ions. Such a separator may be a well-known separator, for example, polyolefin-based polymer membranes such as polypropylene, polyethylene, polyethylene/polypropylene, polyethylene/polypropylene/polyethylene, and polypropylene/polyethylene/polypropylene, or multiple membranes, microporous films, woven fabrics and nonwoven fabrics thereof. In addition, a porous polyolefin film coated with a resin having excellent stability may be used as the separator.

Hereinafter, embodiments of the present disclosure will be described with reference to Examples and Comparative Examples.

### <Experiment 1>Experiment on Capacity Retention Rate at High Temperature (45° C.) According to the Type and Amount of Functional Additive

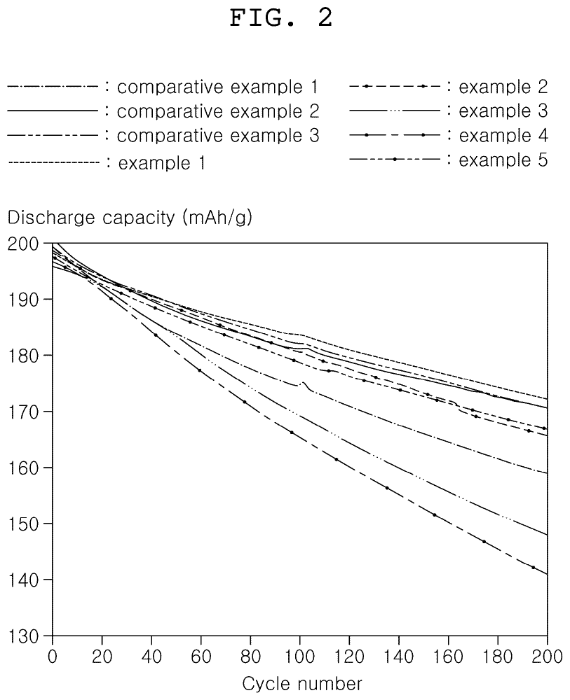

In order to determine a capacity retention rate at high temperature depending on the type and amount of a functional additive added to the electrolyte solution, a capacity retention rate characteristic at a high temperature of 45° C. after 100 cycles and 200 cycles of charging and discharging was measured while the type and amount of the functional additive were changed as shown in the following Table 1, and the results are shown in Table 1 and in FIG. 2.

In this case, the experiment was carried out under the following conditions: a cut-off voltage of 2.5 to 4.2 V, a C-rate of 1 C, and a temperature of 45° C. The lithium salt used to prepare the electrolyte solution was 1M LiPF₆, and the solvent used was a solvent mixture containing ethylene carbonate (EC), ethyl methyl carbonate (EMC), and diethyl carbonate (DEC) at a volume ratio of 25:45:30.

Also, the experiment was conducted under full cell condition using the mixture of NCM811 and NCM622 as the positive electrode and graphite as the negative electrode.

On the other hand, lithium difluorophosphate (LiPO₂F₂) added to the Comparative Examples is a commercially available additive that forms a protective layer on the surfaces of the positive and negative electrodes, and vinylene carbonate (VC) is a commercially available additive that forms a protective layer on the surface of the negative electrode.

TABLE 1

| | | | | Lifespan capacity | |
|---|---|---|---|---|---|
| | Additive (wt %) | | | retention rate (%) | |
| Category | AAB-1 | LiPO₂F₂ | VC | @ 100 cyc | @200 cyc |
| Comparative | — | — | — | 86.9 | 79.2 |
| Example 1 | | | | | |
| Comparative | — | — | 1.0 | 90.8 | 85.1 |
| Example 2 | | | | | |
| Comparative | — | 1.0 | 1.0 | 91.8 | 86.6 |
| Example 3 | | | | | |
| Example 1 | 0.05 | — | 1.0 | 92.6 | 87.0 |
| Example 2 | 0.1 | — | 1.0 | 91.9 | 84.6 |
| Example 3 | 0.5 | — | 1.0 | 86.3 | 75.5 |
| Example 4 | 1.0 | — | 1.0 | 84.4 | 71.8 |
| Example 5 | 0.1 | — | — | 90.6 | 84.5 |

First, as can be seen from Table 1 and FIG. 2, it was confirmed that Examples 1 and 2, in which AAB-1, which was the functional additive according to embodiments of the present disclosure, was added in an amount of 0.05 to 0.1% by weight, significantly improved lifespan capacity retention rate compared to Comparative Example 1 in which no functional additive was added.

In particular, it was confirmed that Examples 1 and 2, in which AAB-1, the functional additive according to embodiments of the present disclosure, was added in an amount of 0.05 to 0.1% by weight, showed equivalent or better improvement in lifespan capacity retention rate compared to Comparative Example 2 in which 1.0% by weight of VC, a commercialized functional additive, was added alone, and Comparative Example 3, in which LiPO₂F₂ and VC, commercialized functional additives, were added in an amount of 1.0% by weight, respectively.

However, it was confirmed that compared to Comparative Example 1 in which no functional additive was added, Examples 3 and 4 in which 0.5 to 1.0% by weight of AAB-1, the functional additive according to embodiments of the present disclosure, were added, showed equivalent or slightly reduced lifespan capacity retention rates. In particular, it was confirmed that as the addition amount of AAB-1, the functional additive according to embodiments of the present disclosure, increased, the cell deteriorated and the lifespan capacity retention rate decreased.

In addition, it was confirmed that comparing Example 5 in which only 0.1% by weight of AAB-1, the functional additive according to embodiments of the present disclosure was added, and Example 2 in which 1.0% by weight of VC was added together with 1.0% by weight of AAB-1, the functional additive according to embodiments of the present disclosure, they were equivalent in terms of lifespan capacity retention rate.

Accordingly, in the case that AAB-1 according to embodiments of the present disclosure was added in an amount of 0.05 to 1.0% by weight as the functional additive, it was confirmed that the capacity retention rate was maintained at 80% or higher after 100 cycles of charging and discharging and at 70% or higher even after 200 cycles of charging and discharging.

In particularly, in the case that AAB-1 according to embodiments of the present disclosure was added in an amount of 0.05 to 0.1% by weight, it was confirmed that the capacity retention rate was maintained at 90% or more after 100 cycles of charging and discharging and at 80% or more even after 200 cycles of charging and discharging.

### <Experiment 2>Experiment on Output Performance at Room Temperature (25° C.) According to the Type and Amount of Functional Additive

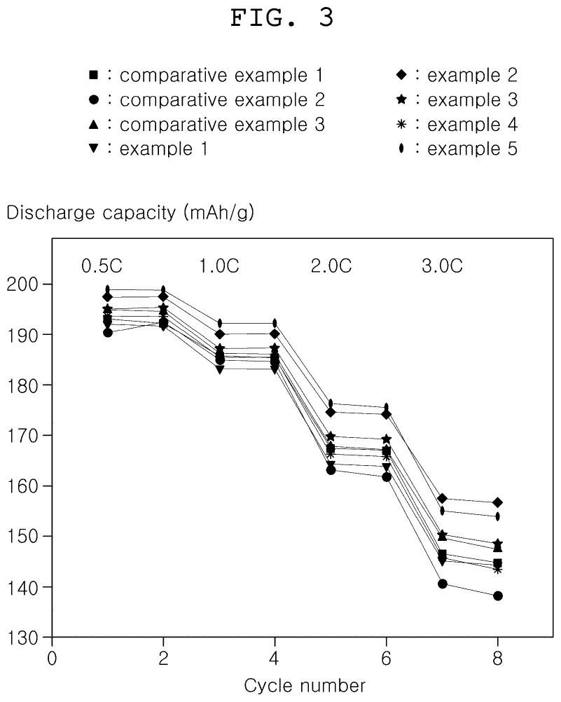

In order to determine the output performance characteristics at room temperature depending on the type and amount of functional additive added to the electrolyte solution, the output performance at room temperature of 25° C. was measured while the type and amount of the functional additive were changed as shown in the following Table 2, and the results are shown in Table 2 and in FIG. 3.

In this case, the experiment was carried out under the following conditions: a cut-off voltage of 2.5 to 4.2 V, a C-rate: charged at 0.5 C, 1.0 C, 2.0 C, 3.0 C/discharged at 0.5 C, and a temperature of 25° C. The lithium salts used to prepare the electrolyte solution were 0.5 M LiPF₆ and 0.5M LiFSI, and the solvent used was a solvent mixture containing ethylene carbonate (EC), ethyl methyl carbonate (EMC), and diethyl carbonate (DEC) at a volume ratio of 25:45:30.

Also, the experiment was conducted under full cell condition using the mixture of NCM811 and NCM622 as the positive electrode and graphite as the negative electrode.

As in Experiment 1, lithium difluorophosphate (LiPO₂F₂) added to the Comparative Examples is a commercially available additive that forms a protective layer on the surfaces of the positive and negative electrodes, and vinylene carbonate (VC) is a commercially available additive that forms a protective layer on the surface of the negative electrode.

TABLE 2

| | | | | Output performance | | |
|---|---|---|---|---|---|---|
| | Additive (wt %) | | | @ xC vs. 0.5 C (%) | | |
| Category | AAB-1 | LiPO₂F₂ | VC | @ 1 C | @2 C | @3 C |
| Comparative | — | — | — | 96.3 | 86.8 | 75.6 |
| Example 1 | | | | | | |
| Comparative | — | — | 1.0 | 96.6 | 84.9 | 72.9 |
| Example 2 | | | | | | |
| Comparative | — | 1.0 | 1.0 | 95.6 | 86.0 | 76.3 |
| Example 3 | | | | | | |
| Example 1 | 0.05 | — | 1.0 | 95.5 | 85.5 | 75.4 |
| Example 2 | 0.1 | — | 1.0 | 96.2 | 88.3 | 79.6 |
| Example 3 | 0.5 | — | 1.0 | 96.0 | 86.8 | 76.6 |
| Example 4 | 1.0 | — | 1.0 | 95.8 | 85.9 | 74.7 |
| Example 5 | 0.1 | — | — | 96.7 | 88.5 | 77.8 |

As can be seen from Table 2 and FIG. 3, it was confirmed that Examples 1 to 4, in which AAB-1, which was the functional additive according to embodiments of the present disclosure, was added in an amount of 0.05 to 1.0% by weight, showed equivalent or better improvement in output performance compared to Comparative Example 2 in which 1.0% by weight of VC, a commercialized additive, was added alone.

In particular, it was confirmed that Examples 1 to 3, in which AAB-1, the functional additive according to embodiments of the present disclosure, was added in an amount of 0.05 to 0.5% by weight, showed equivalent or better improvement in output performance compared to Comparative Example 3 in which 1.0% by weight of VC was added together with LiPO₂F₂, known as an additive with excellent output performance improvement effect.

In addition, it was confirmed that Example 5 in which 0.1% by weight of AAB-1, the functional additive according to embodiments of the present disclosure, was added showed improved output performance compared to Comparative Example 1 in which no functional additive was added.

Accordingly, as can be seen from the above experiments, it was confirmed that in terms of lifespan capacity characteristic at high temperature and output performance at room temperature, at least one of the lifespan capacity characteristic and output performance of the case in which AAB-1, the functional additive according to embodiments of the present disclosure, was added in an amount of 0.05 to 1.0% by weight based on the weight of the electrolyte solution was equal to or better than that of the case in which the functional additive was not added, the commercialized additive VC was added alone, or the commercialized additives LiPO₂F₂ and VC were used together.

In particular, it was confirmed that in order to improve both lifespan capacity characteristic at high temperature and output performance at room temperature, it was preferred to add 0.05 to 0.1% by weight of AAB-1, the functional additive according to embodiments of the present disclosure, based on the weight of the electrolyte solution.

In addition, it was confirmed that AAB-1, the functional additive according to embodiments of the present disclosure, was able to improve both lifespan capacity characteristic at high temperature and output performance at room temperature alone without other additives.

Although embodiments of the present disclosure have been described with reference to the accompanying drawings and the above-described preferred embodiments, the present disclosure is not limited thereto and is defined by the claims described below. Therefore, those skilled in the art will appreciate that various modifications, additions, and substitutions are possible, without departing from the scope and spirit of the present disclosure.

What is claimed is:

1. An electrolyte solution comprising:
a lithium salt;
a solvent; and
a functional additive, wherein the functional additive comprises an electrode film additive of 2-(dodec-1-en-2-ye-4,4,5,5-tetramethyl-1,3,2-dioxaborolane represented by

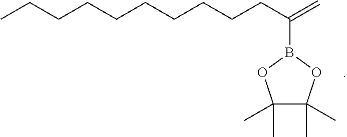 [SMILES: C=C(CCCCCCCCCC)B1OC(C)(C)C(C)(C)O1]

2. The electrolyte solution of claim 1, wherein the electrode film additive is in an amount of 0.05 to 1.0% by weight based on a weight of the electrolyte solution.

3. The electrolyte solution of claim 2, wherein the electrode film additive is in an amount of 0.05 to 0.1% by weight based on the weight of the electrolyte solution.

4. The electrolyte solution of claim 1, wherein the functional additive further comprises a negative-electrode film additive of vinylene carbonate.

5. The electrolyte solution of claim 4, wherein the vinylene carbonate is added in an amount of 0.5 to 3.0% by weight based on a weight of the electrolyte solution.

6. The electrolyte solution of claim 1, wherein the lithium salt comprises one or a mixture of two or more selected from the group consisting of LiPF₆, LiBF₄, LiClO₄, LiCl, LiBr, LiI, LiB₁₀Cl₁₀, LiCF₃SO₃, LiCF₃CO₂, LiAsF₆, LiSbF₆, LiAlCl₁, CH₃SO₃Li, CF₃SO₃Li, LiN(SO₂C₂F₅)₂, Li(CF₃SO₂)₂ N, LiC₄F₉SO₃, LiB(C₆H₅)₄, LiB(C₂O₄)₂, LiPO₂F₂, Li(SO₂F)₂ N, LiFSI, and (CF₃SO₂)₂NLi.

7. The electrolyte solution of claim 1, wherein the solvent comprises one or a mixture of two or more selected from the group consisting of a carbonate-based solvent, an ester-based solvent, an ether-based solvent, and a ketone-based solvent.

8. A lithium secondary battery comprising:
a first electrode;
a second electrode; and
an electrolyte solution disposed between the first electrode and the second electrode, the electrolyte solution comprising:
a lithium salt;
a solvent; and
a functional additive, wherein the functional additive comprises an electrode film additive of 2-(dodec-1-en-2-ye-4,4,5,5-tetramethyl-1,3,2-dioxaborolane represented by

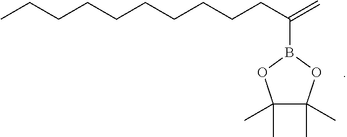 [SMILES: C=C(CCCCCCCCCC)B1OC(C)(C)C(C)(C)O1]

9. The lithium secondary battery of claim 8, wherein the electrode film additive is in an amount of 0.05 to 1.0% by weight based on a weight of the electrolyte solution.

10. The lithium secondary battery of claim 9, wherein the electrode film additive is in an amount of 0.05 to 0.1% by weight based on the weight of the electrolyte solution.

11. The lithium secondary battery of claim 8, wherein the functional additive further comprises a negative-electrode film additive of vinylene carbonate added in an amount of 0.5 to 3.0% by weight based on a weight of the electrolyte solution.

12. The lithium secondary battery of claim 8, wherein the lithium salt comprises one or a mixture of two or more selected from the group consisting of LiPF₆, LiBF₄, LiClO₄, LiCl, LiBr, LiI, LiB₁₀Cl₁₀, LiCF₃SO₃, LiCF₃CO₂, LiAsF₆, LiSbF₆, LiAlCl₁, CH₃SO₃Li, CF₃SO₃Li, LiN(SO₂C₂F₅)₂, Li(CF₃SO₂)₂ N, LiC₄F₉SO₃, LiB(C₆H₅)₄, LiB(C₂O₄)₂, LiPO₂F₂, Li(SO₂F)₂ N, LiFSI, and (CF₃SO₂)₂NLi.

13. The lithium secondary battery of claim 8, wherein the solvent comprises one or a mixture of two or more selected from the group consisting of a carbonate-based solvent, an ester-based solvent, an ether-based solvent, and a ketone-based solvent.

14. A lithium secondary battery comprising: a positive electrode comprising a positive-electrode active material comprising Ni, Co, and Mn;
a negative electrode comprising a negative-electrode active material comprising a carbon (C)-based material or a silicon (Si)-based material;
a separator interposed between the positive electrode and the negative electrode;
an electrolyte solution disposed between the positive electrode and the negative electrode, the electrolyte solution comprising:
a lithium salt;
a solvent; and
a functional additive, wherein the functional additive comprises an electrode film additive of 2-(dodec-1-en-2-yl)-4,4,5,5-tetramethyl-1,3,2-dioxaborolane represented by

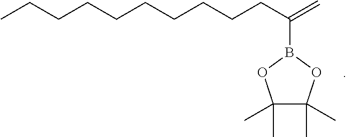 [SMILES: C=C(CCCCCCCCCC)B1OC(C)(C)C(C)(C)O1]

15. The lithium secondary battery of claim 14, wherein the positive electrode comprises a Ni content of 60% by weight or more.

16. The lithium secondary battery of claim 14, wherein the electrode film additive is in an amount of 0.05 to 1.0% by weight based on a weight of the electrolyte solution.

17. The lithium secondary battery of claim 16, wherein the electrode film additive is in an amount of 0.05 to 0.1% by weight based on the weight of the electrolyte solution.

18. The lithium secondary battery of claim 14, wherein the functional additive further comprises a negative-electrode film additive of vinylene carbonate added in an amount of 0.5 to 3.0% by weight based on a weight of the electrolyte solution.

19. The lithium secondary battery of claim 14, wherein the lithium salt comprises one or a mixture of two or more selected from the group consisting of LiPF₆, LiBF₄, LiClO₄, LiCl, LiBr, LiI, LiB₁₀Cl₁₀, LiCF₃SO₃, LiCF₃CO₂, LiAsF₆, LiSbF₆, LiAlCl₁, CH₃SO₃Li, CF₃SO₃Li, LiN(SO₂C₂F₅)₂, Li(CF₃SO₂)₂ N, LiC₄F₉SO₃, LiB(C₆H₅)₄, LiB(C₂O₄)₂, LiPO₂F₂, Li(SO₂F)₂ N, LiFSI, and (CF₃SO₂)₂NLi.

20. The lithium secondary battery of claim 14, wherein the solvent comprises one or a mixture of two or more selected from the group consisting of a carbonate-based solvent, an ester-based solvent, an ether-based solvent, and a ketone-based solvent.
